(19) United States
(12) Patent Application Publication
(10) Pub. No.: US 2025/0363438 A1
(43) Pub. Date: Nov. 27, 2025

(54) SYSTEM AND METHOD FOR EVALUATION, IMPLEMENTATION, AND REFINEMENT OF ENTERPRISE SCORECARDS

(71) Applicant: ORACLE INTERNATIONAL CORPORATION, Redwood Shores, CA (US)

(72) Inventors: Nupur Joshi, Bengaluru (IN); Manisha Gupta, San Ramon, CA (US); Anirban Majumdar, Hyderabad (IN); Sreebhushan Shivapuram, Hyderabad (IN); Raghavendra Raghunath, Bengaluru (IN); Gunvansh Khanna, Edison, NJ (US)

(21) Appl. No.: 18/671,278

(22) Filed: May 22, 2024

(51) Int. Cl. G06Q 10/0639

(52) U.S. Cl. CPC G06Q 10/06393

(57) ABSTRACT

Embodiments described herein are generally related to data analytics, and computer-based methods of providing business intelligence data, and are particularly related to systems and methods for evaluation, implementation, and refinement of key performance indicators, dashboards, or scorecards, for use in analytics-based decision-making. In accordance with an embodiment, a data analytics environment can join several data sets, including an area of responsibility data, in order to determine one or more representatives responsible for particular organization units, during particular periods of time; and identify key measures or metrics under the purview of, or otherwise associated with those representatives, for use in generating a key performance indicator scorecard reflecting such relationships.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to data analytics, and computer-based methods of providing business intelligence data, and are particularly related to systems and methods for evaluation, implementation, and refinement of key performance indicators, dashboards, or scorecards, for use in analytics-based decision-making.

### BACKGROUND

Generally described, within an enterprise organization, data analytics enables computer-based examination of amounts of data, to derive conclusions or other information from the data. For example, business intelligence tools can be used to provide an organization's users with information describing their enterprise data, in a format that enables the users to make strategic business decisions.

Examples of various types of data analytics of interest to enterprise organizations include those related to Enterprise Resource Planning (ERP), Human Capital Management (HCM), Human Resources (HR), Customer Experience (CX), Supply Chain Management (SCM), Enterprise Performance Management (EPM), or other types of data and data analytics use cases.

These are some examples of the types of environments in which data or information describing an enterprise organization's resources can be useful in assisting the organization to make analytics-based decisions based on such data.

### SUMMARY

Embodiments described herein are generally related to data analytics, and computer-based methods of providing business intelligence data, and are particularly related to systems and methods for evaluation, implementation, and refinement of key performance indicators, dashboards, or scorecards, for use in analytics-based decision-making. In accordance with an embodiment, a data analytics environment can join several data sets, including an area of responsibility data, in order to determine one or more representatives responsible for particular organization units, during particular periods of time; and identify key measures or metrics under the purview of, or otherwise associated with those representatives, for use in generating a key performance indicator scorecard reflecting such relationships.

### BRIEF DESCRIPTION OF THE DRAWINGS

FIG. 1 illustrates an example data analytics environment, in accordance with an embodiment.

FIG. 2 further illustrates an example data analytics environment, in accordance with an embodiment.

FIG. 3 further illustrates an example data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 illustrates an example use of a data analytics environment to provide a visualization of key performance indicators or scorecards, in accordance with an embodiment.

FIG. 8 illustrates the use of an area of responsibility data in providing a visualization of key performance indicators or scorecards, in accordance with an embodiment.

FIG. 9 illustrates an example visualization of key performance indicators or scorecards, in accordance with an embodiment.

FIG. 10 illustrates an example user interface for use in evaluation, implementation, and refinement of key performance indicators, dashboards, or scorecards, in accordance with an embodiment.

FIG. 11 further illustrates an example user interface, in accordance with an embodiment.

FIG. 12 further illustrates an example user interface, in accordance with an embodiment.

FIG. 13 further illustrates an example user interface, in accordance with an embodiment.

FIG. 14 further illustrates an example user interface, in accordance with an embodiment.

FIG. 15 further illustrates an example user interface, in accordance with an embodiment.

FIG. 16 further illustrates an example user interface, in accordance with an embodiment.

FIG. 17 further illustrates an example user interface, in accordance with an embodiment.

FIG. 18 illustrates an example process for use of an area of responsibility data in providing a visualization of key performance indicators or scorecards, in accordance with an embodiment.

### DETAILED DESCRIPTION:

Generally described, within an enterprise organization, data analytics enables computer-based examination of amounts of data, to derive conclusions or other information from the data. For example, business intelligence tools can be used to provide an organization's users with information with information describing their enterprise data, in a format that enables the users to make strategic business decisions.

Examples of various types of data analytics of interest to enterprise organizations include those related to Enterprise Resource Planning (ERP), Human Capital Management (HCM), Human Resources (HR), Customer Experience (CX), Supply Chain Management (SCM), Enterprise Performance Management (EPM), or other types of data and data analytics use cases.

Increasingly, data analytics can be provided within the context of software-as-a-service (SaaS) or cloud-based enterprise software environments, such as, for example, Oracle Fusion Applications, Oracle Analytics Cloud or Fusion Analytics Warehouse (FAW).

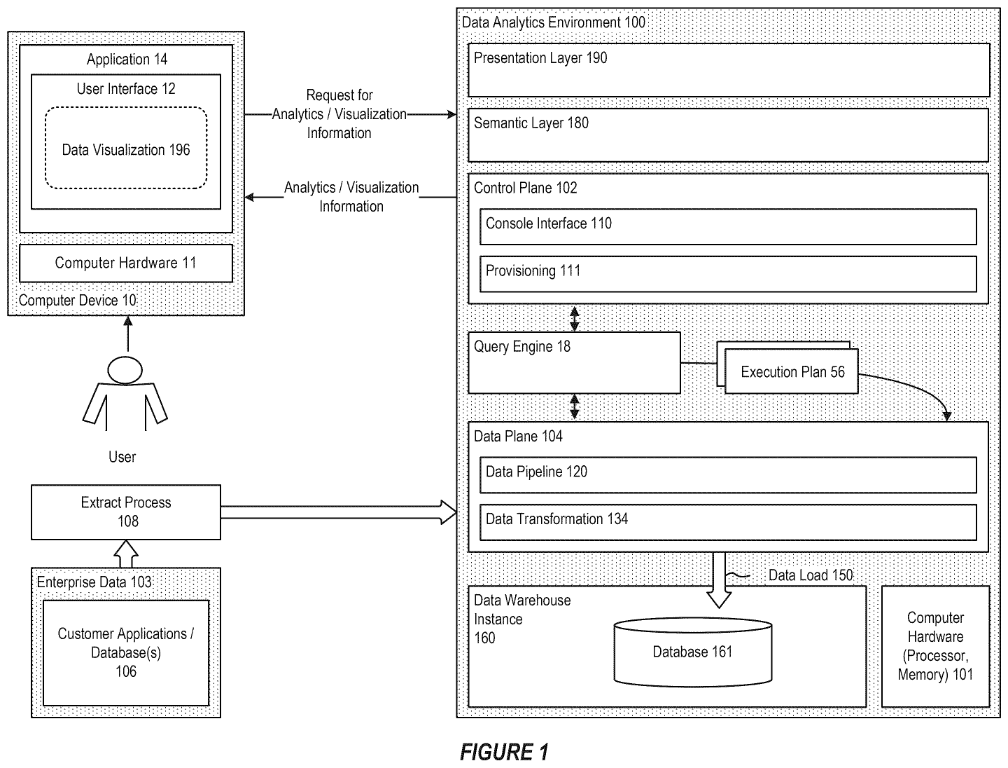

FIG. 1 illustrates an example data analytics environment, in accordance with an embodiment.

The embodiment illustrated in FIG. 1 is provided for purposes of illustrating an example data analytics environment in association with which various embodiments described herein can be used. The components and processes illustrated in FIG. 1 and as described elsewhere herein with regard to various other embodiments, can be provided as software or program code executable by, for example, a cloud computing system, or other suitably-programmed computer system.

As illustrated in FIG. 1, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a customer (tenant) and/or a cloud environment having a provisioning component 111, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 120 and a data transformation layer 134, that together process data from an organization's enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization's enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract data from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for purposes of providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

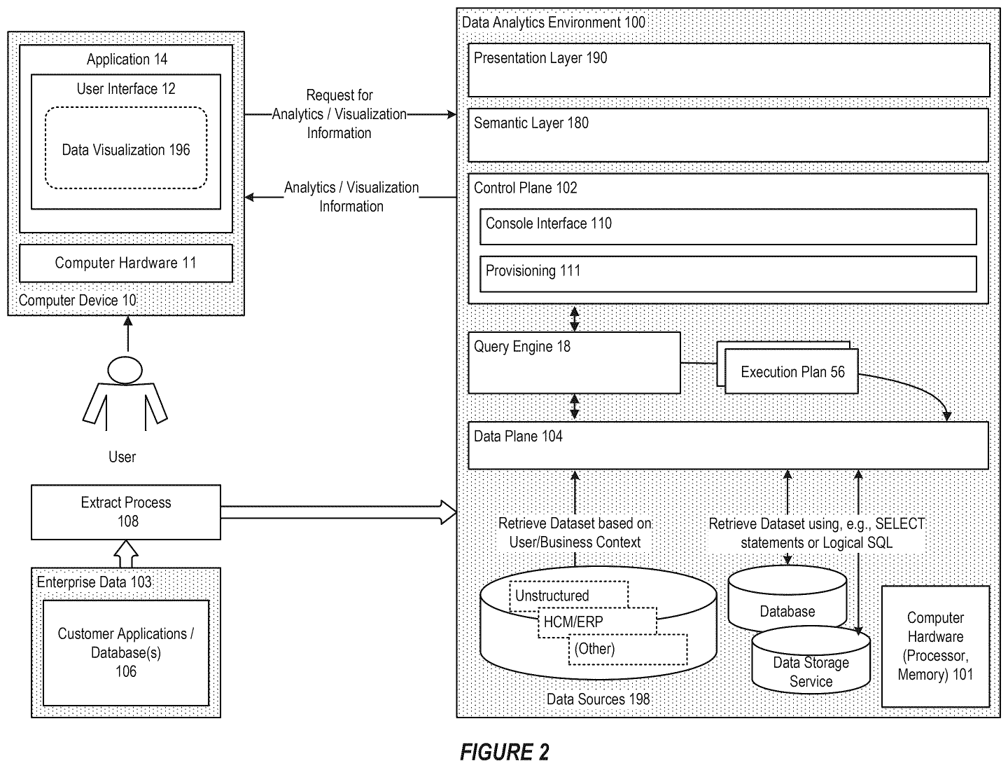

FIG. 2 further illustrates an example data analytics environment, in accordance with an embodiment.

As illustrated in FIG. 2, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), Human Resources (HR), Customer Experience (CX), Supply Chain Management (SCM), Enterprise Performance Management (EPM), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

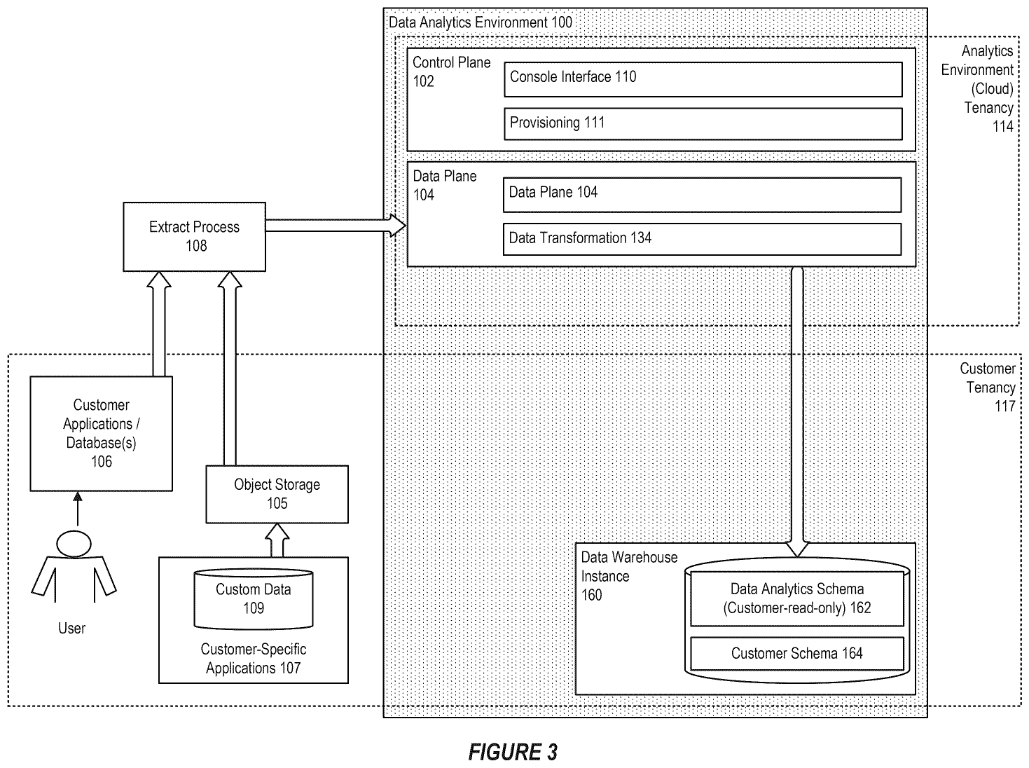

FIG. 3 further illustrates an example data analytics environment, in accordance with an embodiment.

As illustrated in FIG. 3, in accordance with an embodiment, data can be sourced, e.g., from a customer's (tenant's) enterprise software environment (106), using the data pipeline process; or as custom data 109 sourced from one or more customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each customer (tenant) of the system, a customer schema 164. For each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

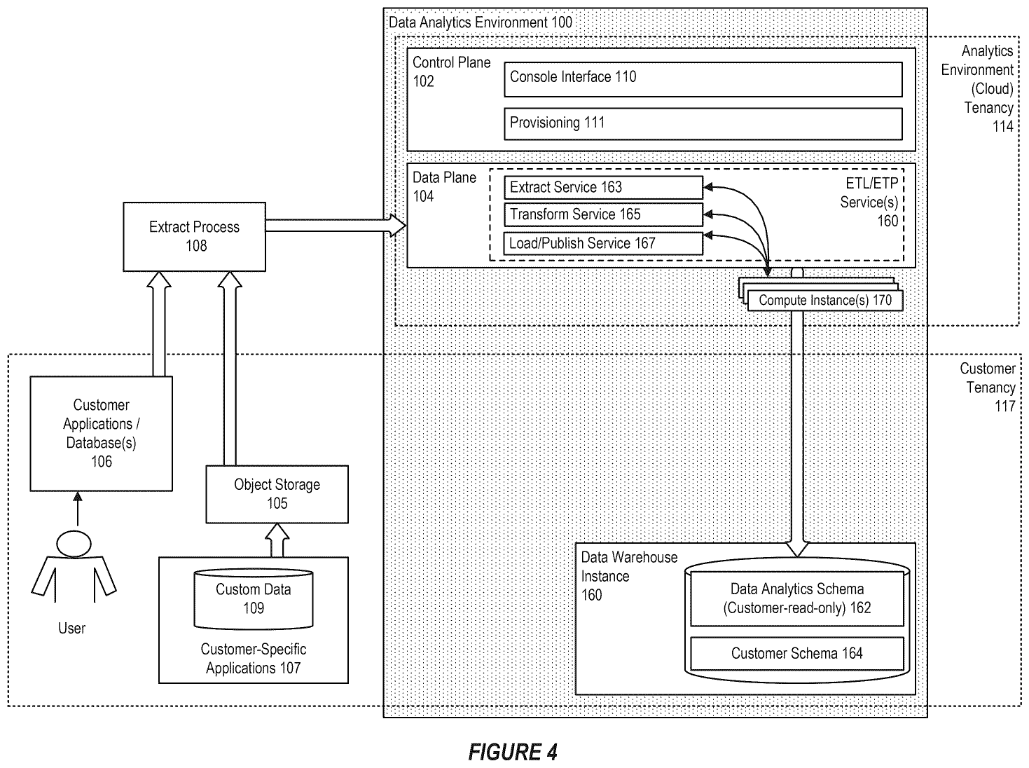

FIG. 4 further illustrates an example data analytics environment, in accordance with an embodiment.

As illustrated in FIG. 4, in accordance with an embodiment, the process of extracting data from a customer's (tenant's) enterprise software environment, and loading the data to a data warehouse instance, or refreshing the data in a data warehouse, generally involves several stages, performed by an ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

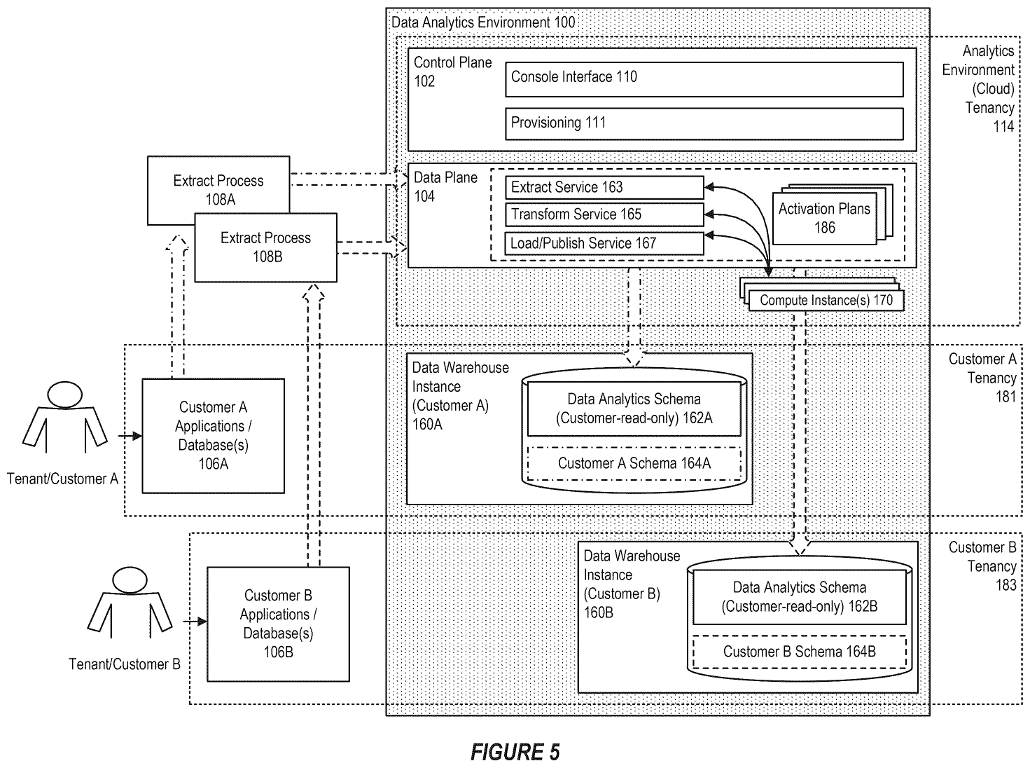

FIG. 5 further illustrates an example data analytics environment, in accordance with an embodiment.

As illustrated in FIG. 5, in accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case. For each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs. For example, an activation plan can define a number of extract, transform, and load (publish) services or steps to be run in a certain order, at a certain time of day, and within a certain window of time.

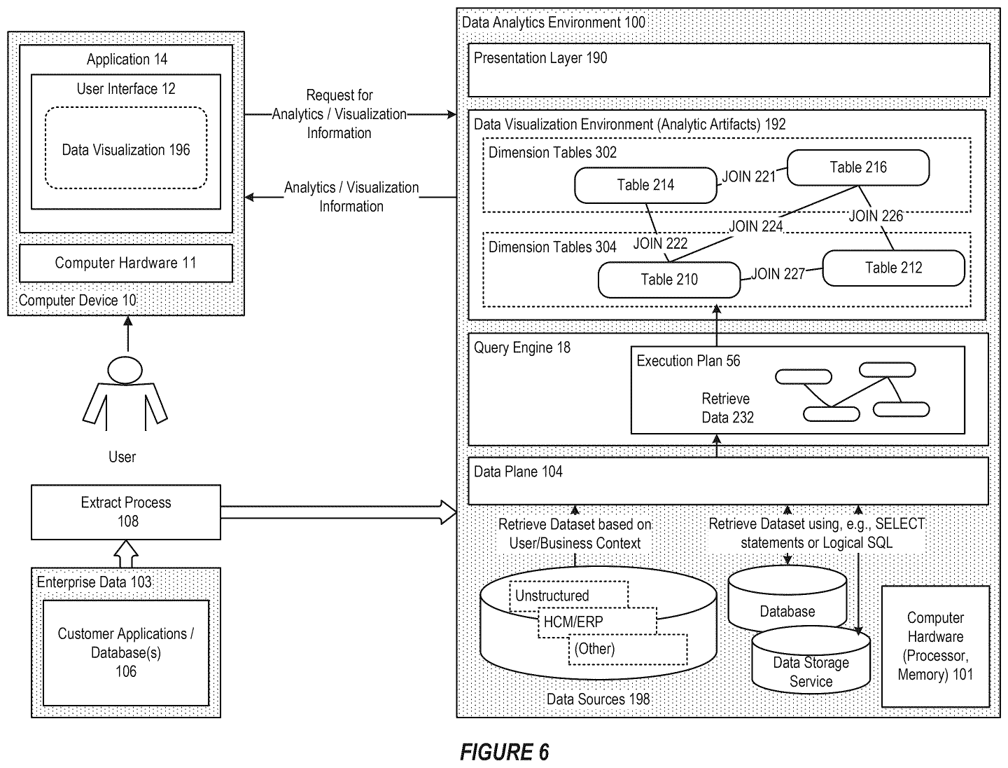

FIG. 6 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 6, in accordance with an embodiment, the data analytics environment enables a dataset to be retrieved, received, or prepared from one or more data source(s), for example via one or more data source connections, fact and/or dimension tables 210-216, or joins 221-227 between selections of dimension tables 302, 304.

In accordance with an embodiment, a request received at a data visualization environment to display analytic artifacts 192, for example as may be related to key performance indicators, dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Evaluation, Implementation, and Refinement of Scorecards

Within an enterprise organization, business executives are tasked with not only making effective decisions regarding the workforce, but also with a need to interpret enterprise data and identify root causes as issues arise. A particular area of interest is improving Human Resources (HR) effectiveness, for example to examine ways to reduce employee termination headcount, or the amount of employee absences.

Within a typical organization, the ratio of HR representatives to employees may be of the order 1:100, with varying ratios based on the size or needs of the organization. Different areas of responsibility can also be associated with each HR representative that effectively provide a segregation of duties amongst the various members of the HR workforce, with particular HR representatives assigned to different parts of the organization to build, maintain, and grow.

In some environments, a variety of key measures or metrics are used to assess, quantify, or provide an indication of the effectiveness of an organization group. For example, a team effectiveness KPI can be used to measure effectiveness of a particular team by assessing its attrition rate, cost, requisition filling rate, or engagement survey score etc., of the team in comparison with the rest of the organization. Such key measures help executives to identify specific managers with high performing teams, and/or assess potential areas of improvement.

Following on the above example, when a particular team has a very high attrition rate, an insufficient headcount, or such talent scarcity, a manager may not be able to resolve this issue alone, and will generally need to partner with a respective HR representatives. Although such HR representatives may not be directly involved in an organization's daily business, their input has a considerable impact on the organization meeting the needs of its internal requirements or external customers, by hiring, retaining, and growing the right talent.

As such, for executives of any organization, it is not only important to have the right HR strategies in place, but also an effective means of evaluating, implementing, and refining that HR strategy.

In accordance with an embodiment, the systems and methods described herein can be used to provide evaluation, implementation, and refinement of key performance indicators, dashboards, or scorecards, for example human resource (HR) scorecards, for use in an enterprise organization's analytics-based decision-making.

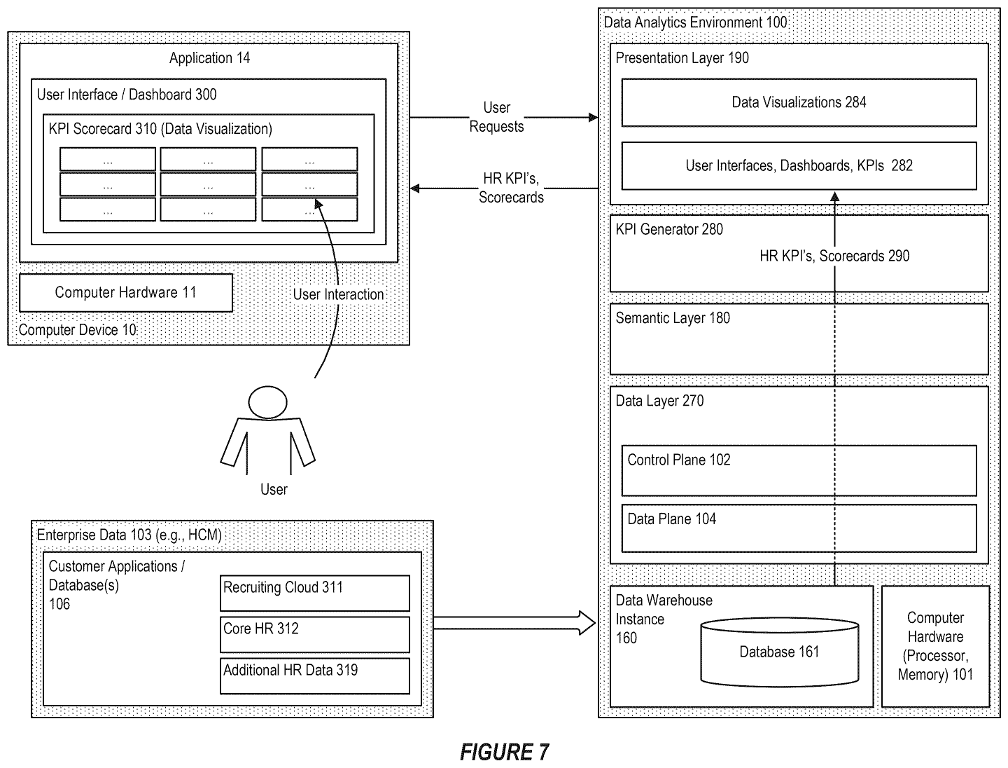

FIG. 7 illustrates an example use of a data analytics environment to provide a visualization of key performance indicators or scorecards, in accordance with an embodiment.

As illustrated in FIG. 7, in accordance with an embodiment, a data analytics environment, for example as described above, can include a KPI generator 280 that receives information via a data layer 270 from a data warehouse instance, and enables generation of enterprise data (e.g., HR) KPIs or scorecards 290, associated with the enterprise organization.

In accordance with an embodiment, the system can be accessed by a user using a client computer device, for example as described above. In response to a request, the system can receive, from the data warehouse instance, an (e.g., HR) enterprise data, and generate a user interface, dashboard, or KPI 282, for use as one or more data visualizations 284, and for subsequent display at a client user interface or dashboard 300, for example as a two-dimensional KPI scorecard 310, matrix, chart, or other data display or visualization format.

When used with HR enterprise data, such data can include for example, a recruiting cloud data 311, core HR data 312, or additional HR data 319, as further described below.

In accordance with various embodiments, the teachings described herein can be used with various systems and methods for providing or supporting the use of data analytics or KPIs, such as, for example, the systems and methods described in U.S. Patent Application titled “SYSTEM AND METHOD FOR DATA ANALYTICS WITH AN ANALYTIC APPLICATIONS ENVIRONMENT”, application Ser. No. 16/862,394, filed Apr. 29, 2020, and subsequently published as U.S. Patent Application Publication No. 2020/0349155 on Nov. 5, 2020; or U.S. Patent Application titled “TECHNIQUES FOR DATA-DRIVEN CORRELATION OF METRICS”, application Ser. No. 16/586,347, filed Sep. 27, 2019, and subsequently published as U.S. Patent Application Publication No. 2020/0104775 on Apr. 2, 2020; each of which patent applications and the contents thereof are herein incorporated by reference.

### Area of Responsibility (AOR)

In accordance with an embodiment, the system can use an area of responsibility (AOR) data, for example as provided by a customer's Human Capital Management (HCM) data, e.g., a Fusion Data Intelligence platform, for use in visualizing key measures or metrics at a level of HR representative.

In accordance with an embodiment, an area of responsibility (AOR) data allows the customer to set security roles, based on a person's scope of responsibility, which determines, for example, which records they can see or act on. This approach improves security performance and reduces the number of profiles and data roles that must be managed and updated as people's roles change within the organization.

Organizations may have varied needs for managing data security, from granting broad access, to replicating the exact access granted in their HCM data. To support this, when HCM data is received into the data analytics environment, the security associated with the HCM data can be used to configure data access, for example by business unit, legal employer, country, or department.

In accordance with an embodiment, the data analytics environment can extract AOR data from a customer's HCM data, and load it into a data warehouse instance, as generally described above. Each customer (tenant) of the environment can be associated with their own customer tenancy; and can be additionally provided with read-only access to the data analytics schema. The AOR data can be seeded in an immutable data analytics schema, which can then be supplemented by customer-specific data as needed.

In accordance with an embodiment, the system can then compare, based on assessing the AOR data, various measures or metrics at a level of HR representative, such as, for example: headcount; male/female gender ratio; salary; attrition; retention; new hire; new hire attrition; voluntary/involuntary termination; workers with approved/rejected/withdrawn absences; count of approved absences; total absence hours/total absence days; high performer count/low performer count/medium performer count; overall performance evaluation process completion; overall goal setting process completion; learning hours; total openings; total job requisition; total applications.

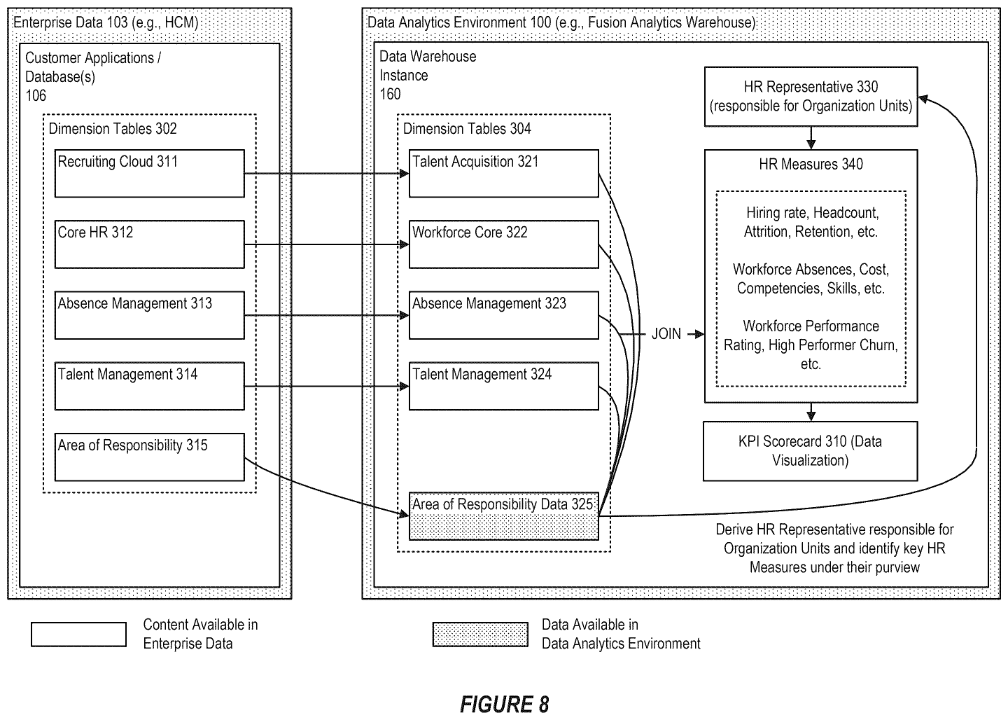

FIG. 8 illustrates the use of an area of responsibility data in providing a visualization of key performance indicators or scorecards, in accordance with an embodiment.

As illustrated in FIG. 8, in accordance with an embodiment, an enterprise data 103, for example a customer's HCM database, operates as a source of truth from which enterprise data such as HR data can be extracted and receiving in the data analytics environment.

In accordance with an embodiment, such HR data can include for example, a recruiting cloud data (e.g., recruiting date), or core HR data (e.g., employee lifecycle, hiring, promotion details) as described above, and/or additional HR data such as absence management data 313, talent management data 314 (e.g., performance review, language skills), and area of responsibility data 315.

In accordance with an embodiment, each of the data present in the enterprise data can be extracted, transformed, and loaded into a data warehouse instance as described above, as a corresponding talent acquisition data 321 workforce core data 322, absence management data 323, and talent management data 324. The data analytics environment can then join the several data sets with its own sets of data, including AOR data 325, in order to (a) derive one or more HR representative 330 responsible for particular organization units, during particular periods of time; and (b) identify key measures or metrics 340 under the purview of, or otherwise associated with those HR representatives, for use in generating a KPI scorecard reflecting such relationships.

In accordance with an embodiment, use of an area of responsibility data enables not only HR managers, but various HR representatives for all sections of organizations to be identified; for example, compensation representatives responsible for governing overall fairness in compensation planning and distribution process; or HR representatives responsible for overall hiring, absence policies, learning initiatives. By bringing this data into the data warehouse, in addition to simplifying security configuration, the system can be used to identify an individual HR representative for various organizational aspects.

For example, in accordance with an embodiment, a performance KPI can be generated to illustrate changes in the data associated with particular responsible persons or HR representative over different periods of time.

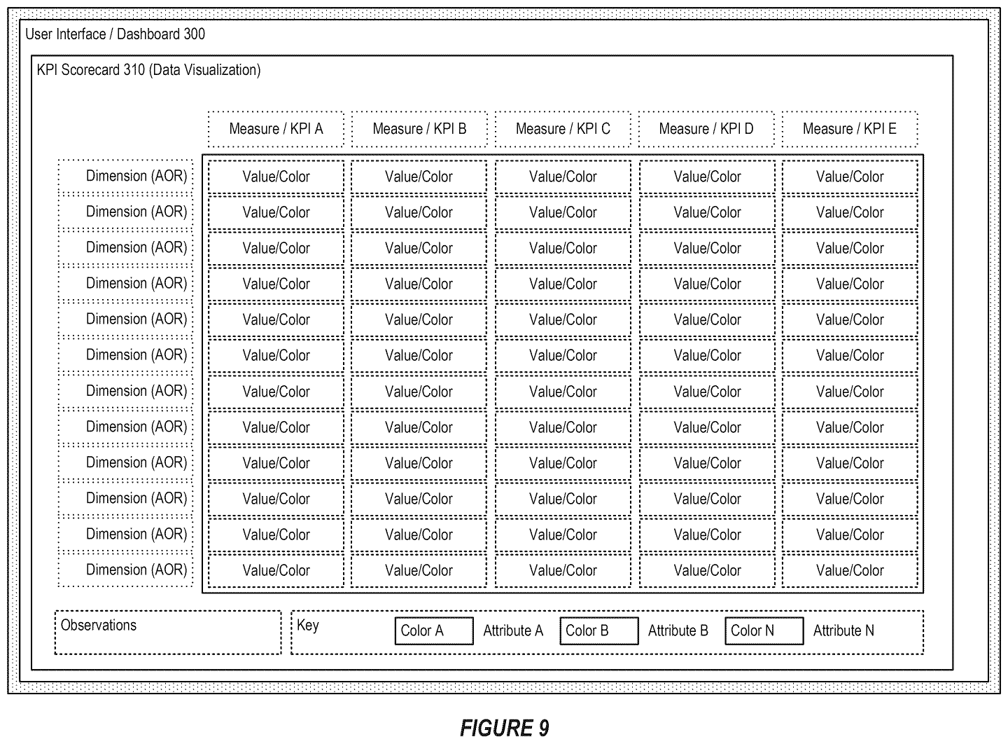

FIG. 9 illustrates an example visualization of key performance indicators or scorecards, in accordance with an embodiment.

As illustrated in FIG. 9, in accordance with an embodiment, a data analytics environment includes or provides access to a data warehouse instance for storage of enterprise data.

In accordance with an embodiment, the system can retrieve into the data analytics environment an enterprise data comprising one or more organization entity datasets, and derive, based on assessing an area of responsibility data associated with the organization entity datasets, one or more entity (e.g., HR) representatives responsible for particular organization units, and identify key measures associated with each entity representative.

In accordance with an embodiment, the system can generate a user interface, dashboard, or KPI for subsequent display at a client user interface or dashboard 300, for example as a two-dimensional KPI scorecard 310, matrix, chart, or other data display or visualization format, comparing one or more organization units within the organization, indicative of the relationship of particular entity representatives on key performance indicators.

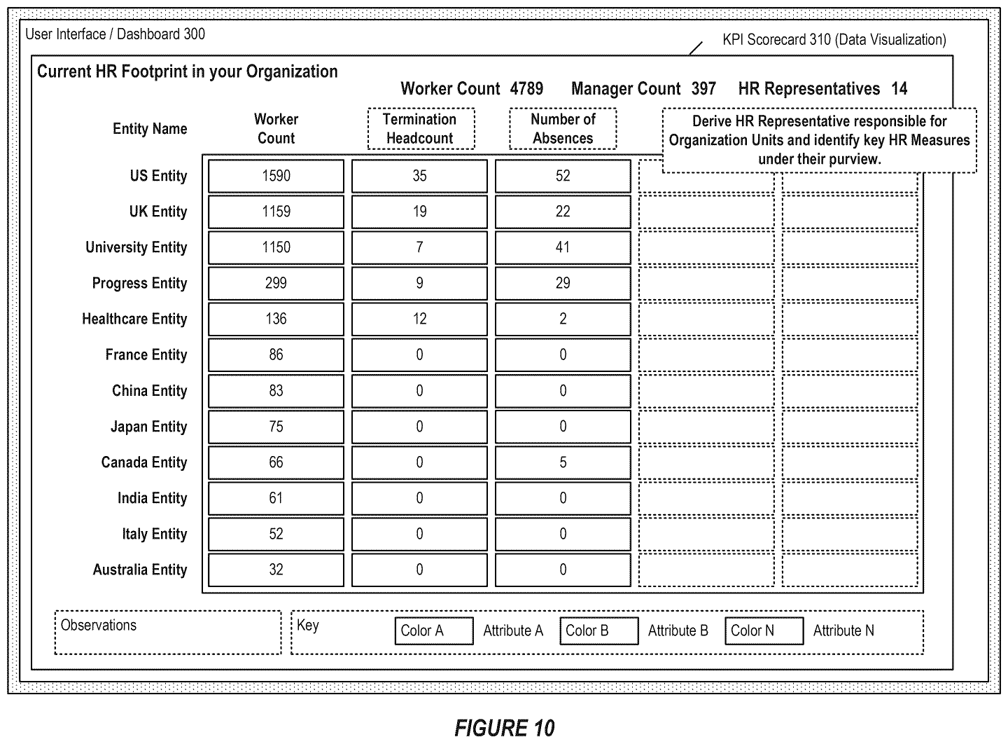

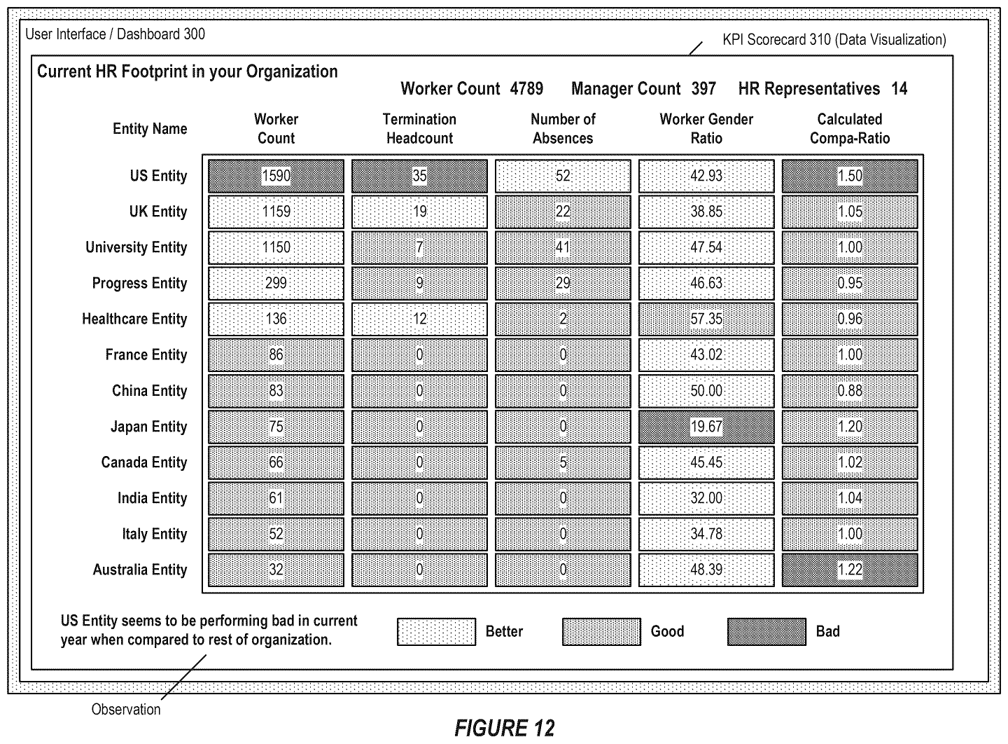

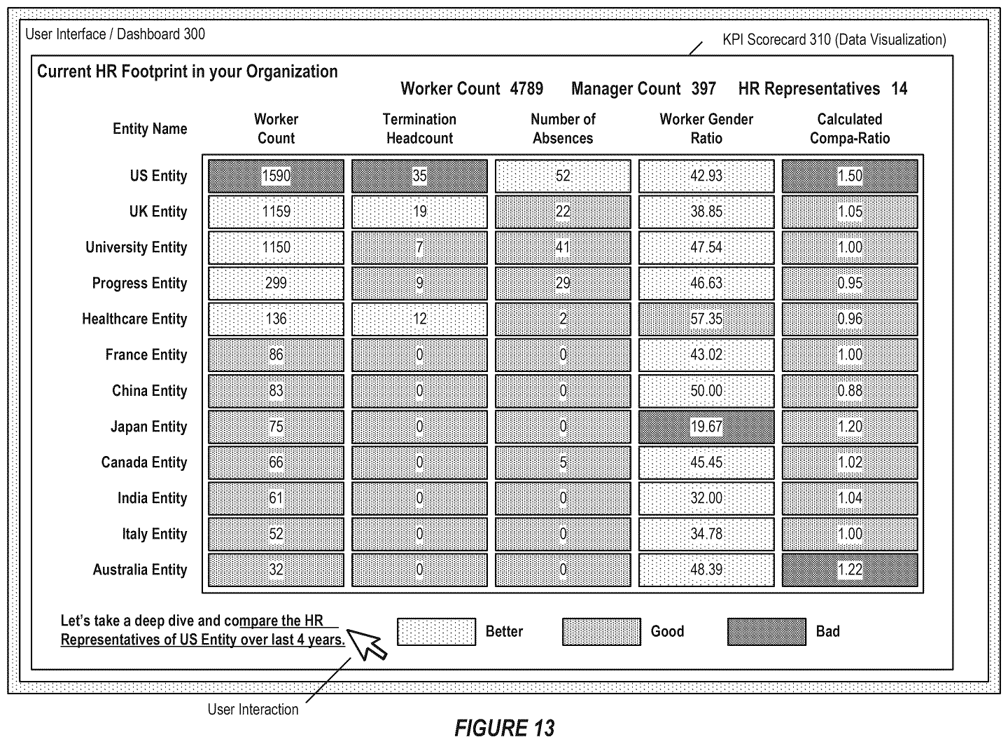

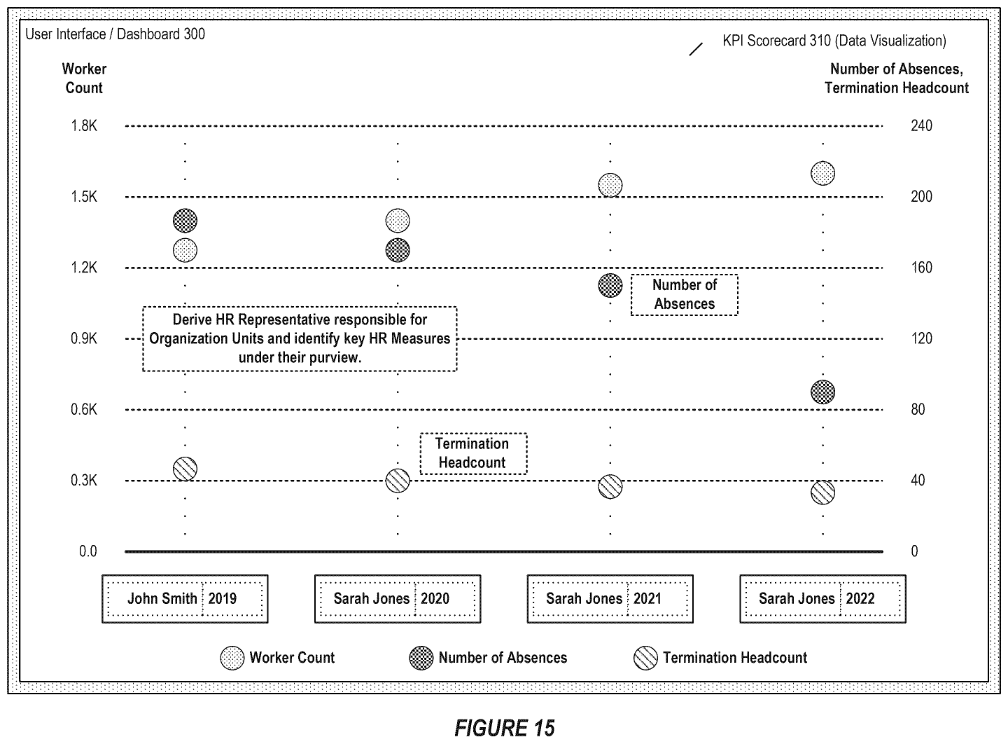

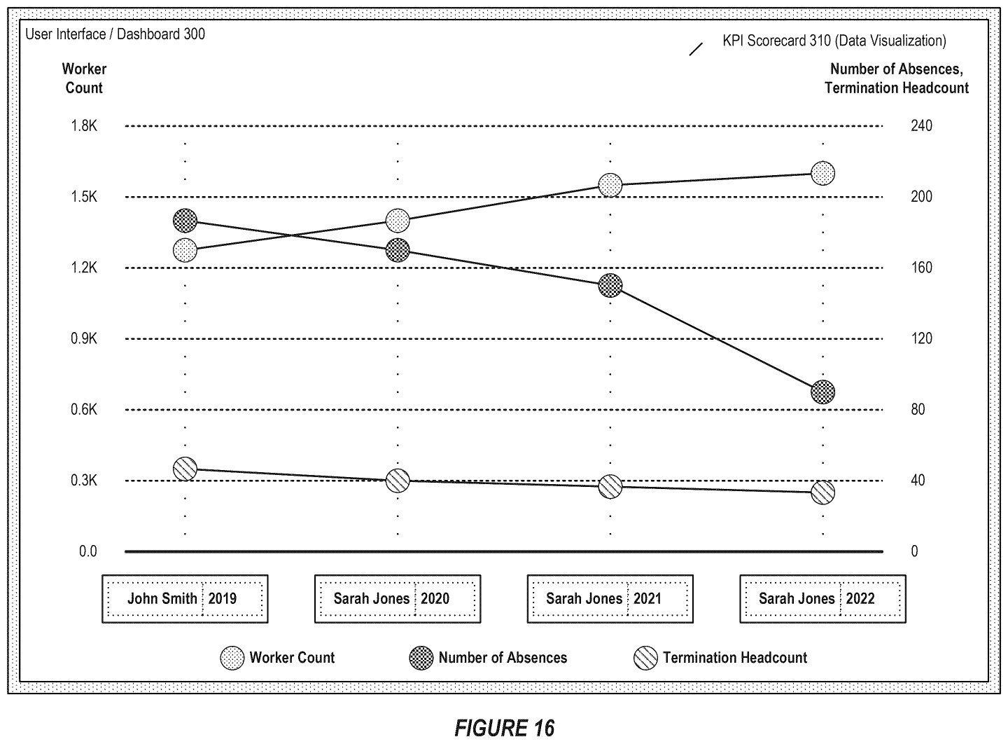

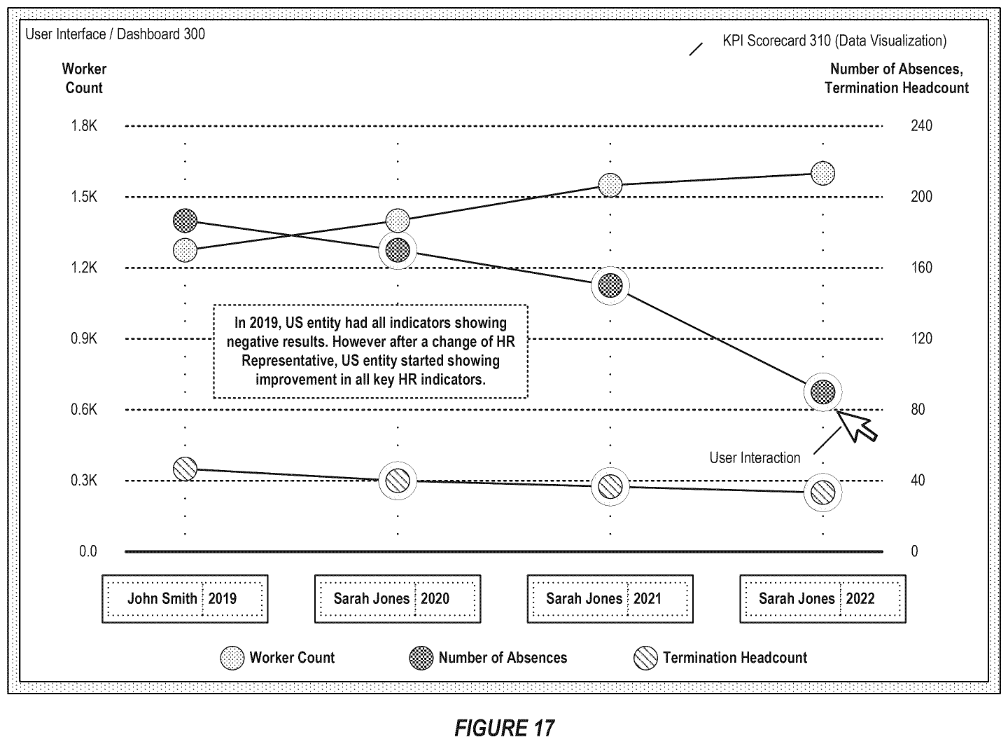

FIGS. 10-17 illustrates an example user interface for use in evaluation, implementation, and refinement of key performance indicators, dashboards, or scorecards, in accordance with an embodiment.

As illustrated in the example of FIG. 10, a user interface or dashboard can include a matrix of columns, wherein each column operates as a KPI of key measures, reflecting (in this example) data from the workforce core dataset, and the absence management datasets.

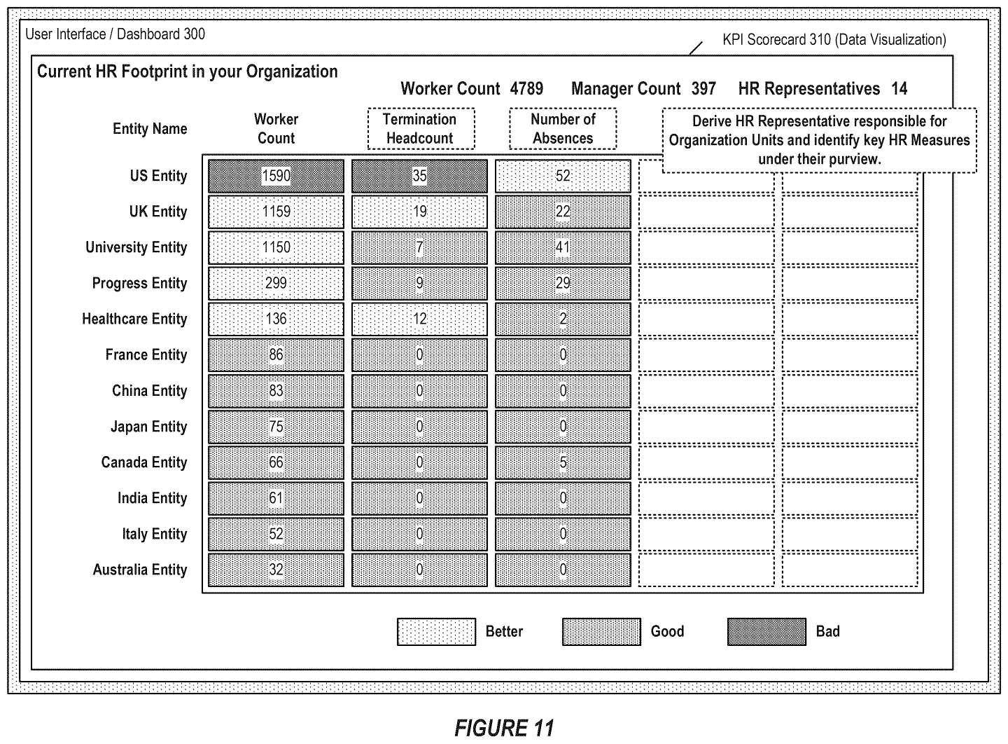

As illustrated FIGS. 11-13, based on certain conditions the system can indicate within the user interface or dashboard various KPIs or measures with values or colors. Optionally, the system can display observations or insights related to the data, such as for example: “US Entity seems to be performing bad in current year when compared to rest of organization”; or can allow a user to interact with the visualization, for example: “Let's take a deep dive and compare the HR Representatives of US Entity over last 4 years”. The user can then click on or interact with the visualization to drill-down into the data.

The above are provided by way of example; in accordance with various embodiments, the dashboard or visualization can include other types of key measures.

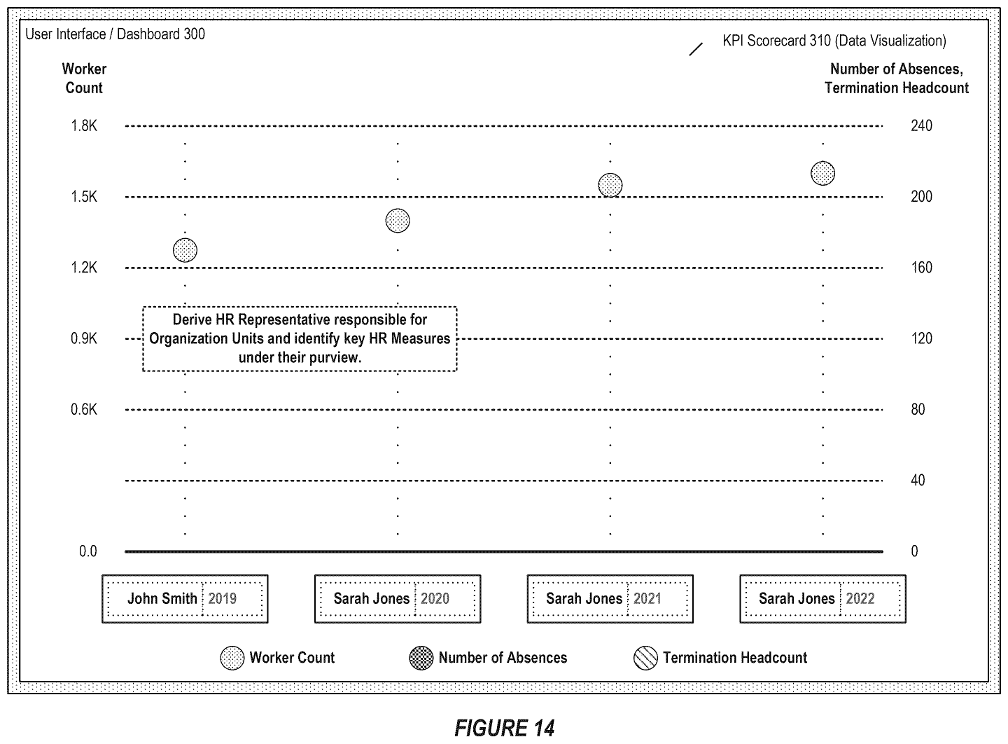

As illustrated in FIGS. 14-17, drilling-down, the visualization can indicate (in this example) that, with a change in HR representative in 2020, various key measures have started to improve, and that the trend continues to improve in following years. Optionally, the system can display observations or insights related to the data, such as for example: “In 2019, US entity had all indicators showing negative results. However after a change of HR Representative, US entity started showing improvement in all key indicators”; and/or allow interaction for example to drill-down further into particular items of data.

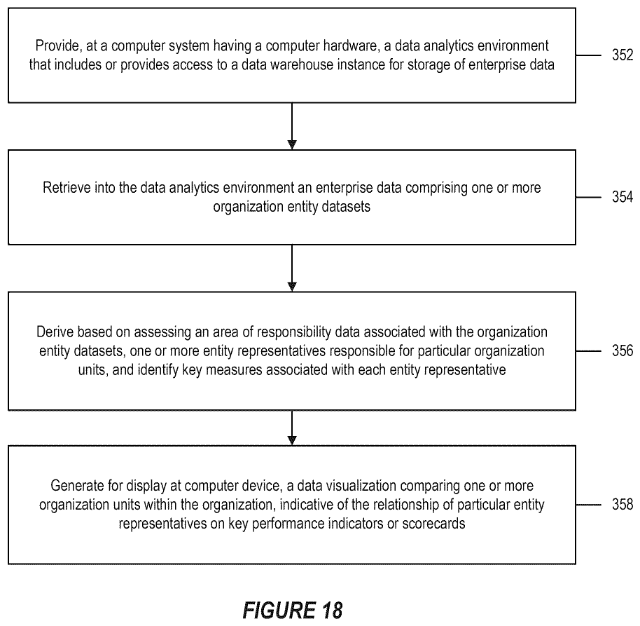

FIG. 18 illustrates an example process for use of an area of responsibility data in providing a visualization of key performance indicators or scorecards, in accordance with an embodiment.

As illustrated in FIG. 18, in accordance with an embodiment, at step 352, the process or method includes providing, at a computer system having a computer hardware, a data analytics environment that includes or provides access to a data warehouse instance for storage of enterprise data.

At step 354, the method includes retrieving into the data analytics environment an enterprise data comprising one or more organization entity datasets

At step 356, the system can derive, based on assessing an area of responsibility data associated with the organization entity datasets, one or more entity (e.g., HR) representatives responsible for particular organization units, and identify key measures associated with each entity representative.

At step 358, the system can then generate for display at computer device, a data visualization comparing one or more organization units within the organization, indicative of the relationship of particular entity representatives on key performance indicators.

### Example Use Cases

In accordance with various embodiments, the systems and methods described herein can be used, for example to:

Identify HR representatives of various organization units (e.g., department, business unit, legal employer, country) and plot key measures or metrics against each HR representative responsible for each organization unit.

Compare key measures or metrics for each organization unit with other corresponding organization units, thereby comparing effectiveness of individual HR representatives responsible for that organization unit.

Assist executives to identify and design improvement planning for the HR workforce.

Identify a span of control of each HR representative.

Analyze organization-wide visibility of HR policies and initiatives. Attrition/retention is not only a problem to be solved for business-critical aspects of an organization; a HR department also suffers when not adequately staffed or without sufficient growth opportunities.

The above are provided by way of example; in accordance with various embodiments, the systems and methods described herein can be used to address additional use cases.

In accordance with various embodiments, the teachings herein can be implemented using one or more computer, computing device, machine, or microprocessor, including one or more processors, memory and/or computer readable storage media programmed according to the teachings herein. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Further modifications and variations will be apparent to the practitioner skilled in the art.

The embodiments were chosen and described in order to best explain the principles of the teachings herein and their practical application, thereby enabling others skilled in the art to understand the various embodiments and with various modifications that are suited to the particular use contemplated. It is intended that the scope be defined by the following claims and their equivalents.

What is claimed is:

1. A system for evaluation, implementation, and refinement of key performance indicators, dashboards, or scorecards, comprising:
a data analytics system that provides access to a database of enterprise data, including data descriptive of entities within an enterprise organization;
wherein an area of responsibility data is used by the system to provide one or more evaluation, implementation, and refinement of key performance indicators, dashboards, or scorecards, including:
determining one or more representatives responsible for particular organization units, during particular periods of time; and
identifying key measures or metrics associated with the one or more representatives and indicative of relationships between a representative and an entity performance, for use in generating a key performance indicator scorecard reflecting such relationships.

2. The system of claim 1, wherein the one or more representatives responsible for particular organization units is a human resources (HR) representative, and wherein the key measures or metrics associated with the human resources representative includes HR measures for the particular organization units during the particular periods of time.

3. The system of claim 1, wherein the data analytics environment extracts the area of responsibility data from an enterprise organization customer data, and loads it into a data warehouse instance, wherein the area of responsibility data can be seeded in an immutable data analytics schema, which can then be supplemented by customer-specific data as needed.

4. The system of claim 1, wherein in response to a request received at a data visualization environment, the data analytics environment operates to join several data sets with its area of responsibility data, to generate a user interface, dashboard, or key performance indicator (KPI) for subsequent display at a client user interface or dashboard as a KPI scorecard comparing one or more organization units within the organization indicative of the relationship of particular entity representatives on key performance indicators.

5. The system of claim 1, wherein the organization units are teams provided within the enterprise organization.

6. The system of claim 1, wherein the identifying of key measures or metrics associated with the one or more representatives and indicative of relationships between a representative and an entity performance are displayed as a key performance indicator scorecard reflecting such relationships for use in making analytics-assisted decisions.

7. A method for evaluation, implementation, and refinement of key performance indicators, dashboards, or scorecards, comprising:
accessing a database of enterprise data, including data descriptive of a plurality of teams within an enterprise organization; and
assessing an area of responsibility data stored in the database to provide one or more evaluation, implementation, and refinement of key performance indicators, dashboards, or scorecards, including:
determining one or more representatives responsible for particular organization units, during particular periods of time; and
identifying key measures or metrics associated with the one or more representatives and indicative of relationships between a representative and an entity performance, for use in generating a key performance indicator scorecard reflecting such relationships.

8. The method of claim 7, wherein the one or more representatives responsible for particular organization units is a human resources (HR) representative, and wherein the key measures or metrics associated with the human resources representative includes HR measures for the particular organization units during the particular periods of time.

9. The method of claim 7, wherein the data analytics environment extracts the area of responsibility data from an enterprise organization customer data, and loads it into a data warehouse instance, wherein the area of responsibility data can be seeded in an immutable data analytics schema, which can then be supplemented by customer-specific data as needed.

10. The method of claim 7, wherein in response to a request received at a data visualization environment, the data analytics environment operates to join several data sets with its area of responsibility data, to generate a user interface, dashboard, or key performance indicator (KPI) for subsequent display at a client user interface or dashboard as a KPI scorecard comparing one or more organization units within the organization indicative of the relationship of particular entity representatives on key performance indicators.

11. The method of claim 7, wherein the organization units are teams provided within the enterprise organization.

12. The method of claim 7, wherein the identifying of key measures or metrics associated with the one or more representatives and indicative of relationships between a representative and an entity performance are displayed as a key performance indicator scorecard reflecting such relationships for use in making analytics-assisted decisions.

13. A non-transitory computer readable storage medium having instructions thereon, which when read and executed by a computer cause the computer to perform a method comprising:
accessing a database of enterprise data, including data descriptive of a plurality of teams within an enterprise organization; and
assessing an area of responsibility data stored in the database to provide one or more evaluation, implementation, and refinement of key performance indicators, dashboards, or scorecards, including:
determining one or more representatives responsible for particular organization units, during particular periods of time; and
identifying key measures or metrics associated with the one or more representatives and indicative of relationships between a representative and an entity performance, for use in generating a key performance indicator scorecard reflecting such relationships.

14. The non-transitory computer readable storage medium of claim 13, wherein the one or more representatives responsible for particular organization units is a human resources (HR) representative, and wherein the key measures or metrics associated with the human resources representative includes HR measures for the particular organization units during the particular periods of time.

15. The non-transitory computer readable storage medium of claim 13, wherein the data analytics environment extracts the area of responsibility data from an enterprise organization customer data, and loads it into a data warehouse instance, wherein the area of responsibility data can be seeded in an immutable data analytics schema, which can then be supplemented by customer-specific data as needed.

16. The non-transitory computer readable storage medium of claim 13, wherein in response to a request received at a data visualization environment, the data analytics environment operates to join several data sets with its area of responsibility data, to generate a user interface, dashboard, or key performance indicator (KPI) for subsequent display at a client user interface or dashboard as a KPI scorecard comparing one or more organization units within the organization indicative of the relationship of particular entity representatives on key performance indicators.

17. The non-transitory computer readable storage medium of claim 13, wherein the organization units are teams provided within the enterprise organization.

18. The non-transitory computer readable storage medium of claim 13, wherein the identifying of key measures or metrics associated with the one or more representatives and indicative of relationships between a representative and an entity performance are displayed as a key performance indicator scorecard reflecting such relationships for use in making analytics-assisted decisions.
